(19) United States
(12) Patent Application Publication
(10) Pub. No.: US 2013/0057130 A1
(43) Pub. Date: Mar. 7, 2013

(54) GASKET APPLICABLE TO LAUNDRY TREATMENT APPARATUS, LAUNDRY TREATMENT APPARATUS HAVING THE SAME, AND MANUFACTURING METHOD AND INJECTION MOLD FOR THE SAME

(71) Applicants: Dong Won KIM, Gyeonggi-do (KR); Hong Kon Kim, Gyeonggi-do (KR); Jong Won Park, Gyeonggi-do (KR); Ye Ho Yang, Gyeonggi-do (KR); Young Jae Kim, Incheon (KR)

(72) Inventors: Dong Won KIM, Gyeonggi-do (KR); Hong Kon Kim, Gyeonggi-do (KR); Jong Won Park, Gyeonggi-do (KR); Ye Ho Yang, Gyeonggi-do (KR); Young Jae Kim, Incheon (KR)

(73) Assignee: SAMSUNG ELECTRONICS CO., LTD., Suwon-si (KR)

(21) Appl. No.: 13/602,962

(22) Filed: Sep. 4, 2012

(30) Foreign Application Priority Data
Sep. 5, 2011 (KR) 10-2011-0089845
Nov. 14, 2011 (KR) 10-2011-0118087

(51) Int. Cl. D06F 37/26; F16J 15/02; B29C 45/26

(52) U.S. Cl. 312/228; 264/161; 425/588; 312/296; 277/650

(57) ABSTRACT

A gasket and a manufacturing method and injection mold for the same are disclosed herein, in which the gasket includes a body composed of an injection molded product made from a thermoplastic elastomer while having a hollow portion and a circumferential portion enclosing a periphery of the hollow portion, and a lip which protrudes from an edge of the circumferential portion toward the hollow portion. The gasket includes a front surface coming into contact with a door when the gasket is installed in a laundry treatment apparatus and a back surface disposed behind the front surface. The back surface of the lip may be formed with an overflow protrusion during molding of the gasket. The overflow protrusion may be molded later than the lip, thereby preventing generation of poor molding at the front surface of the lip.

### CROSS-REFERENCE TO RELATED APPLICATIONS

This application claims the benefits of Korean Patent Application No. 10-2011-0089845 filed on Sep. 5, 2011 and Korean Patent Application No. 10-2011-0118087 filed on Nov. 14, 2011 in the Korean Intellectual Property Office, the disclosures of which are incorporated herein by reference.

### BACKGROUND

1. Field

Embodiments of the present invention disclosed herein relate to a gasket capable of being applied to a laundry treatment apparatus.

2. Description of the Related Art

In general, a laundry treatment apparatus refers to a machine which treats laundry such as clothes, bedclothes, etc. using electric power. The laundry treatment apparatus includes a washing machine which removes pollutants stained on the laundry using water, detergents, and interaction of a rotary drum, and a drying machine which dries wet laundry using hot air generated by a heater.

The laundry treatment apparatus may include a cabinet formed with an opening to insert the laundry, a door to open and close the opening of the cabinet, a tub disposed within the cabinet for storage of water, and a drum which is rotatably mounted within the tub. When the drum is rotated by a motor in a state in which the laundry and detergent water are inserted into the drum, the laundry rubs against the drum and the detergent water, thereby removing pollutants stained on the laundry.

A gasket may be installed between the drum and the door in order to prevent water leakage therebetween and vibration transfer to the cabinet during rotation of the drum.

The gasket may be manufactured by compression molding of ethylene-propylene-diene (EPDM) terpolymer rubber. However, when the gasket is manufactured using EPDM rubber, there are problems in that productivity is lowered due to a long molding time and it is difficult to recycle defective products or life-expired products.

### SUMMARY

Therefore, it is an aspect of the present invention to provide a gasket capable of being manufactured through injection molding and a laundry treatment apparatus having the same.

It is another aspect of the present invention to provide a gasket having an improved external appearance and a laundry treatment apparatus having the same.

It is a further aspect of the present invention to provide a manufacturing method and an injection mold capable of preventing generation of poor molding during manufacture of a gasket applicable to a laundry treatment apparatus.

Additional aspects of the invention will be set forth in part in the description which follows and, in part, will be apparent from the description, or may be learned by practice of the invention.

In accordance with one aspect of the present invention, a gasket applicable to a laundry treatment apparatus includes a cabinet having an opening and a door to open and close the opening, a body composed of an injection molded product made from a thermoplastic elastomer while having a hollow portion and a circumferential portion enclosing a periphery of the hollow portion, a lip which protrudes from an edge of the circumferential portion toward the hollow portion while having a front surface coming into contact with the door when the gasket is installed in the laundry treatment apparatus and a back surface disposed behind the front surface, and at least one overflow protrusion which protrudes from the back surface of the lip so that the overflow protrusion is molded later than the front surface of the lip during molding of the gasket.

The overflow protrusion may include a lip connection portion which extends rearward from the back surface of the lip and has a thinner thickness than the lip.

The overflow protrusion may further include an enlargement portion which extends rearward from the lip connection portion and is formed thicker than the lip connection portion.

The lip may have an inner side end protruding relative to an inner surface of the circumferential portion, and the overflow protrusion may be disposed closer to the inner side end of the lip than the inner surface of the circumferential portion.

The circumferential portion of the body may include a plurality of gate corresponding portions formed so as to respectively correspond to gates arranged at an injection mold for molding of the gasket.

The plural gate corresponding portions may be comprised of a first gate corresponding portion and a second gate corresponding portion disposed next to the first gate corresponding portion in a circumferential direction of the body, and the overflow protrusion may be disposed at a central portion between the first and second gate corresponding portions.

The lip may be formed with a parting line corresponding to an area at which two molds meet during the molding of the gasket, and the parting line may be positioned at the back surface of the lip.

The circumferential portion may be formed, at an inner surface thereof, with fine protrusions to irregularly reflect light.

The inner surface of the circumferential portion formed with the fine protrusions may have surface roughness in a range of about 0.5 μm to 100 μm.

The thermoplastic elastomer may include at least one of styrene-ethylene-butylene-styrene (SEBS), styrene-ethylene-propylene-styrene (SEPS), and styrene-ethylene-ethylene-propylene-styrene (SEEPS).

In accordance with another aspect of the present invention, a laundry treatment apparatus includes a cabinet having an opening into which laundry is inserted, a door mounted at the cabinet to open and close the opening, a drum rotatably mounted within the cabinet, and a gasket disposed between the cabinet and the door while being composed of an injection molded product made from a thermoplastic elastomer, in order to attenuate transfer of vibration to the cabinet during rotation of the drum, wherein the gasket includes a body which has a hollow portion receiving a portion of the door and a circumferential portion enclosing a periphery of the hollow portion, and a lip which protrudes from the circumferential portion of the body toward the door while having a front surface directed toward the door to come into contact with the door and a back surface directed toward the drum, and wherein the lip is formed with a parting line positioned at the back surface thereof, and the parting line corresponds to an area at which two molds meet during injection molding of the gasket.

The gasket may include a cutting surface formed after removal of a protrusion formed at the back surface of the lip during injection molding of the gasket.

The gasket may further include an overflow protrusion which is formed at the back surface of the lip and is positioned adjacent to the parting line.

The circumferential portion may be formed, at an inner surface thereof, with fine protrusions to irregularly reflect light, and the inner surface of the circumferential portion formed with the fine protrusions may have surface roughness in a range of about 0.5 μm to 100 μm.

In accordance with another aspect of the present invention, a manufacturing method for a gasket applicable to a laundry treatment apparatus including a cabinet having an opening and a door to open and close the opening is disclosed. The manufacturing method for the gasket applicable to the laundry treatment apparatus may include preparing an injection mold which includes a cavity having a shape corresponding to a product to be injection-molded and at least one gate to inject a molding material into the cavity, injecting a melted thermoplastic elastomer into the cavity through the gate and then forming an injection molded product having a cylindrical body and a lip protruding from the cylindrical body, the lip coming, at a front surface thereof, into contact with the door of the laundry treatment apparatus when the injection molded product is installed in the laundry treatment apparatus, forming an overflow protrusion at a back surface of the lip, the overflow protrusion being molded later than the front surface of the lip during formation of the lip, and removing the overflow protrusion from the injection molded product.

The manufacturing method for the gasket applicable to the laundry treatment apparatus may further include forming fine protrusions to irregularly reflect light on an inner peripheral surface of the body.

The at least one gate may include a plurality of pin holes so as to allow the melted thermoplastic elastomer to be dispersed and injected into the cavity.

Each of the pin holes may be about 0.3 mm to 1.0 mm in diameter.

The injection mold may include two molds engaged with each other so as to form a cavity corresponding to the lip, and the manufacturing method may further include forming a parting line at the back surface of the lip, the parting line being formed by an area where the two molds are engaged.

In accordance with a further aspect of the present invention, an injection mold used to mold a gasket including a cylindrical body having a circumferential portion and a lip protruding from an end of the circumferential portion is disclosed. The injection mold may include first and second molds disposed to face each other, a first intermediate mold disposed between the first and second molds while forming a lip cavity corresponding to the lip of the gasket together with the first mold, and a second intermediate mold disposed at a periphery of the first intermediate mold so as to form a cavity corresponding to the circumferential portion of the gasket, wherein the first intermediate mold includes an overflow cavity communicating with the lip cavity so as to provide a space capable of receiving a molding material overflowing after filling the lip cavity during injection molding of the gasket.

The first intermediate mold may include a circumferential surface to form the cavity corresponding to the circumferential portion of the gasket, and the circumferential surface may be surface-treated so as to form fine protrusions on the circumferential portion of the gasket.

The injection mold may further include a gate to inject the molding material into a cavity formed by the first mold, second mold, the first intermediate mold, and the second intermediate mold, wherein the gate may include pin holes, and each of the pin holes may be about 0.3 mm to 1.0 mm in diameter.

The overflow cavity may include a first portion formed narrower than the lip cavity and a second portion formed wider than the first portion.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a view illustrating a laundry treatment apparatus according to an exemplary embodiment of the present invention;

FIG. 2 is an enlarged view illustrating a portion of FIG. 1;

FIG. 3 is a sectional view illustrating a gasket according to the exemplary embodiment of the present invention;

FIGS. 4 and 5 are sectional views illustrating an injection mold for manufacture of the gasket according to the exemplary embodiment of the present invention;

FIG. 6 is a perspective view illustrating a gate member of the injection mold shown in FIG. 4;

FIG. 7 is a rear perspective view illustrating the gasket according to the exemplary embodiment of the present invention;

FIG. 8 is an enlarged sectional view illustrating a portion of the gasket according to the exemplary embodiment of the present invention;

FIG. 9 is a sectional view illustrating a portion to mold a lip of the gasket and one overflow protrusion in the injection mold according to the exemplary embodiment of the present invention; and

FIG. 10 is a perspective view illustrating a state in which the overflow protrusion is removed from the gasket according to the exemplary embodiment of the present invention.

### DETAILED DESCRIPTION

Reference will now be made in detail to the embodiments of the present invention, examples of which are illustrated in the accompanying drawings, wherein like reference numerals refer to like elements throughout.

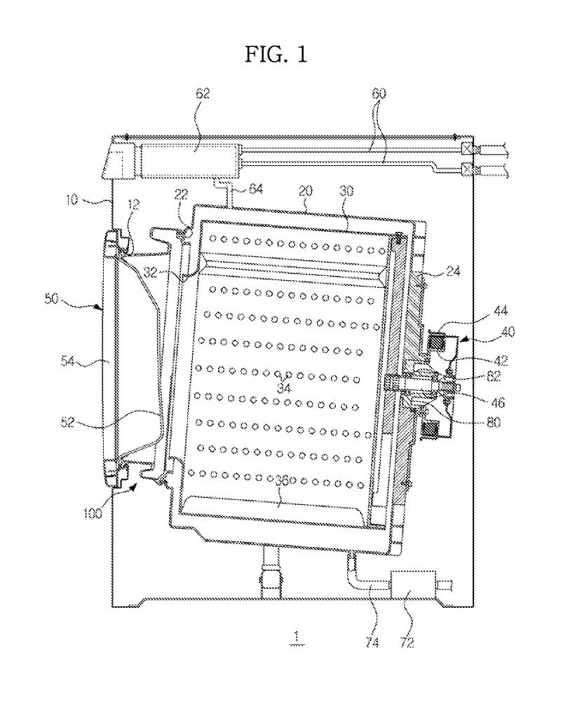

As shown in FIG. 1, the laundry treatment apparatus, which is designated by reference numeral 1, may include a cabinet 10 defining an external appearance thereof, a tub 20 mounted within the cabinet 10 for storage of water, a drum 30 rotatably disposed within the tub 20, and a motor 40 to drive the drum 30.

The cabinet 10 is formed, at a front portion thereof, with an opening 12. The opening 12 of the cabinet 10 is opened and closed by a door 50 mounted at the front portion of the cabinet 10. The door 50 includes a door glass 52 arranged to enable an interior of the drum 30 to be viewed and a door frame 54 to support the door glass 52.

Openings 22 and 32 corresponding to the opening 12 of the cabinet 12 are formed at front portions of the tub 20 and drum 30, respectively, so as to insert laundry into the drum 30.

Water supply pipes 60 are installed above the tub 20 in order to supply the tub 20 with wash water. Each of the water supply pipes 60 is connected, at one side thereof, to an outer water supply source (not shown) while being connected, at the other side thereof, to a detergent supply unit 62. The detergent supply unit 62 is connected to the tub 20 through a connection pipe 64. Water supplied through the water supply pipes 60 is supplied into the tub 20 via the detergent supply unit 62 together with detergents.

A drain pump 72 and a drain pipe 74 are installed beneath the tub 20 in order to discharge the water within the tub 20 to the outside of the cabinet 10.

The drum 30 is formed, at a circumference thereof, with multiple through holes 34 through which wash water flows, and lifters 36 are mounted on inner peripheral surface of the drum 30 so that the laundry may be tumbled during rotation of the drum 30.

The motor 40 is mounted at a rear wall 24 of the tub 20. The motor 40 includes a stator 42 fixed to the tub 20 and a rotor 44 rotatably disposed around the stator 42. The rotor 44 is rotated by electromagnetic interaction with the stator 42 and transfers rotational force to a drive shaft 46.

The drive shaft 46 transfers the rotational force of the motor 40 to the drum 30. The drive shaft 46 is connected, at one end thereof, to the drum 30 while extending, at the other end thereof, to the outside of the rear wall 24 of the tub 20 to be coupled to the rotor 44.

The tub 20 is mounted, at the rear wall 24 thereof, with a bearing housing 80 to rotatably support the drive shaft 46. The bearing housing 80 may be made of an aluminum alloy material and be inserted into the rear wall 24 of the tub 20 when the tub 20 is injection-molded. Bearings 82 are fitted between the bearing housing 80 and the drive shaft 46 so as to allow the drive shaft 46 to be smoothly rotated.

A gasket 100 is installed between the tub 20 and the door 50. The gasket 100 is disposed between the opening 12 of the cabinet 10 and the opening 22 of the tub 20 to define a passage which reaches the opening 32 of the drum 30 from the opening 12 of the cabinet 10, and attenuates transfer of vibration to the cabinet 10 during rotation of the drum 30. Also, the gasket 100 is partially disposed between the door 50 and the cabinet 10 to prevent water in the tub 20 from leaking to the outside of the cabinet 10.

The gasket 100 may be composed of an injection molded product made from a thermoplastic elastomer. Since the thermoplastic elastomer has elasticity such as a rubber at room temperature, the gasket 100 made from the thermoplastic elastomer may efficiently attenuate transfer of vibration from the tub 20 to the cabinet 10. Also, when the gasket 100 is injection-molded in the thermoplastic elastomer, productivity may be improved, compared with compression molding of ethylene-propylene-diene (EPDM) rubber.

The gasket 100 made from the thermoplastic elastomer may have a Shore A hardness in a range of about 30 to 50. The gasket 100 having this range of hardness may satisfy mechanical strength such as tensile strength required for a washing machine gasket and may attenuate transfer of vibration to the cabinet 10.

A composition providing a raw material for the gasket 100 includes a hydrogenated styrene block copolymer. The hydrogenated styrene block copolymer may include one or more selected from the group consisting of styrene-ethylene-butylene-styrene (SEBS), styrene-ethylene-propylene-styrene (SEPS), and styrene-ethylene-ethylene-propylene-styrene (SEEPS).

Also, petroleum softener may be added to the composition for the gasket 100 in order to lower hardness of the thermoplastic elastomer composition. The petroleum softener may have a kinematic viscosity in a range of about 100 to 250 at a temperature of 40° C. When the kinematic viscosity at 40° C. of the petroleum softener is within the above-mentioned range, no tire marks or flow marks are formed during molding of the gasket. Naphthenic oil or paraffin oil may be used as the petroleum softener.

This softener content may be in a range of about 60 parts by weight to 150 parts by weight relative to 100 parts by weight of the styrene block copolymer. When the softener content is within this range, low hardness required for the gasket may be sufficiently attained and oil is not separated during molding of the gasket, thereby enabling prevention of oil bleeding.

In addition, polyolefin may be added to the composition for the gasket 100 in order to improve heat resistance and strength of the thermoplastic elastomer composition. Although the added polyolefin may be one or more selected from the group consisting of linear and non-linear polyethylene and polypropylene, polypropylene may be used to improve heat resistance.

The polyolefin content may be in a range of about 10 parts by weight to 30 parts by weight relative to 100 parts by weight of the styrene block copolymer. When the polyolefin content is within the above-mentioned range, it may be possible to attain strength, heat resistance, and elastic restoration force of the elastomer required for the washing machine gasket.

Furthermore, an inorganic filler may be added to the composition for the gasket 100 in order to improve specific gravity and tear resistance of the thermoplastic elastomer composition. Examples of the inorganic filler may include, but are not limited to, calcium carbonate (CaCo₃), clay, diatomaceous earth, talc, barium sulfate, magnesium carbonate, metal oxides, graphite, aluminum hydroxide, etc.

This inorganic filler content may be in a range of about 10 parts by weight to 50 parts by weight relative to 100 parts by weight of the styrene block copolymer. When the inorganic filler content is within the above-mentioned range, it may be possible to attain specific gravity and low hardness required for the gasket as well as improvement in chemical resistance and strength.

Still furthermore, a thermally stable polymer may be added to the composition for the gasket 100 in order to improve high-temperature tensile strength and a high-temperature stretch deformation rate (stability after being subjected to high-temperature) of the thermoplastic elastomer composition. Polyphenylene oxide (PPO), polyphenylene ether (PPE), or derivatives thereof may be used as the thermally stable polymer.

The thermally stable polymer content may be in a range of about 10 parts by weight to 50 parts by weight relative to 100 parts by weight of the styrene block copolymer. When the thermally stable polymer content is within the above-mentioned range, it may be possible to accomplish remarkable improvement in high-temperature tensile strength and stability after being subjected to high-temperature as well as low hardness.

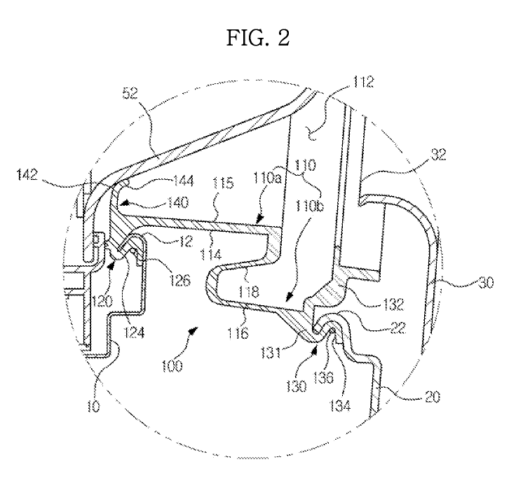

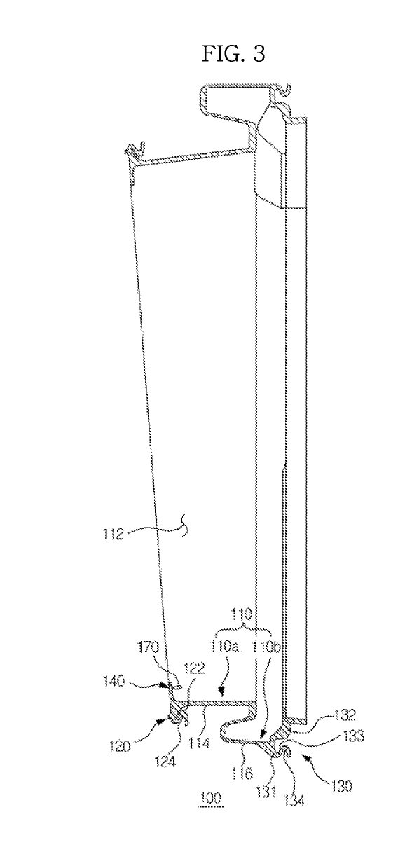

As shown in FIGS. 2 and 3, the gasket 100 has a body 110 disposed between the opening 12 of the cabinet 10 and the opening 32 of the drum 30 when being mounted in the laundry treatment apparatus 1. The body 110 includes a hollow portion 112 defining a passage to insert laundry into and take laundry out of the drum 30, and circumferential portions 114 and 116 enclosing a periphery of the hollow portion 112. When the door 50 is closed, the door glass 52 is accommodated within the hollow portion 112 of the gasket 100.

The body 110 may include a first body part 110a and a second body part 110b. The first body part 110a is coupled, at a front end thereof, to the opening 12 of the cabinet 10 while being positioned, at a rear end thereof, close to the opening 22 of the tub 20.

The second body part 110b has a diameter greater than a diameter of the first body part 110a. The second body part 110b is coupled, at a rear end thereof, to the opening 22 of the tub 20 while being positioned, at a front end thereof, forward of the rear end of the first body part 110a. Hereinafter, the circumferential portion 114 of the first body part 110a is referred to as a first circumferential portion, whereas the circumferential portion 116 of the second body part 110b is referred to as a second circumferential portion.

The rear end of the first body part 110a is connected to the front end of the second body part 110b through a connection portion 118. The connection portion 118 has a structure which is bent several times, thereby efficiently attenuating transfer of vibration from the tub 20 to the cabinet 10.

The front end of the first body part 110a is provided with a cabinet coupling part 120. The cabinet coupling part 120 includes a cabinet coupling groove 122 arranged at an outer side in a radial direction of the first circumferential portion 114 and a first wire groove 124 arranged at an outer side of the cabinet coupling groove 122.

The cabinet coupling groove 122 is engaged with an edge of the cabinet 10 forming the opening 12. The first wire groove 124 is coupled with a wire 126 to prevent separation of the gasket 100 from the cabinet 10.

The rear end of the second body part 110b is provided with a tub coupling part 130. The tub coupling part 130 includes a first flange 131 extending from the second circumferential portion 116 toward the tub 20 and a second flange 132 extending firm the second circumferential portion 116 toward the drum 30.

A tub coupling groove 133 is formed between the first and second flanges 131 and 132, and a second wire groove 134 is arranged at an outer surface of the first flange 131. The tub coupling groove 133 is engaged with an edge of the tub 20 forming the opening 22. The second wire groove 134 is coupled with a wire 136 to prevent separation of the gasket 100 from the tub 20.

Meanwhile, the first body part 110a is formed, at the front end thereof, with a lip 140. The lip 140 protrudes from an inner surface 115 of the first circumferential portion 114 toward the hollow portion 112 while being formed in a ring shape along a circumferential direction of the first circumferential portion 114. The lip 140 is directed, at a front surface 142 thereof, toward the door 50, and a back surface 144 behind the front surface 142 is directed toward the drum 30. When the door 50 of the laundry treatment apparatus 1 is closed, the front surface 142 of the lip 140 comes into contact with the door glass 52 to be sealed, thereby preventing water from leaking between the door 50 and the cabinet 10.

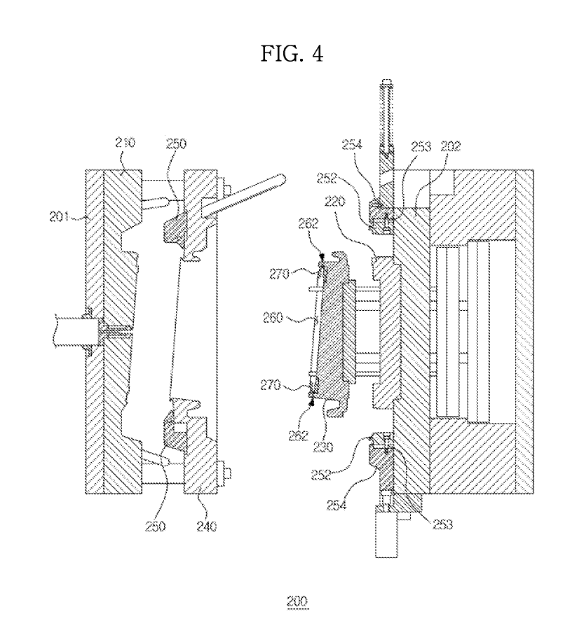

Hereinafter, an injection mold to mold the gasket according to an exemplary embodiment of the present invention will be described with reference to FIGS. 4 to 6.

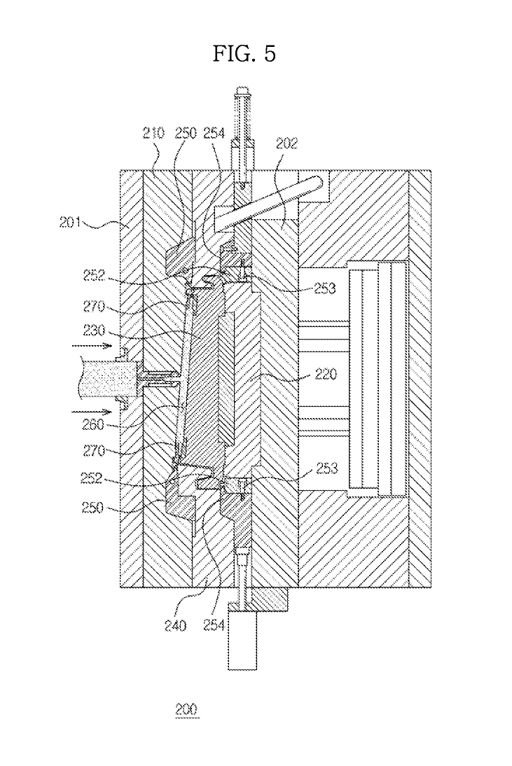

As shown in FIGS. 4 and 5, the injection mold 200 includes first and second fixed plates 201 and 202, a first mold 210 fixedly installed at the first fixed plate 201, a second mold 220 fixedly installed at the second fixed plate 202 while being disposed to face the first mold 210, a first intermediate mold 230 disposed between the first and second molds 210 and 220 while having an outer surface corresponding to an inner surface of the gasket 100 to be manufactured, and a second intermediate mold 240 disposed at an outer side of the first intermediate mold 230 while having an inner surface corresponding to an outer surface of the gasket 100 to be manufactured.

Any one of the first and second molds 210 and 220 may be movably installed so that a clearance between the first and second molds 210 and 220 may be changed. In the present exemplary embodiment, the first mold 210 is movably installed so that the first mold 210 moves toward or recedes from the second mold 220. Also, each of the first and second intermediate molds 230 and 240 is movably installed between the first and second molds 210 and 220.

In addition, the injection mold 200 includes slide cores 250, 252 and 254 to form the cabinet coupling part 120 and tub coupling part 130 of the gasket 100. The slide cores 250, 252 and 254 are comprised of first slide cores 250 movably installed at the second intermediate mold 240 for formation of the cabinet coupling part 120, second slide cores 252 movably installed at the second fixed plate 202 for formation of the tub coupling part 130, and third slide cores 254.

Accordingly, a cavity, which has a shape corresponding to the gasket 100 to be manufactured, is formed between the first mold 210, the second mold 220, the first intermediate mold 230, the second intermediate mold 240, the first slide cores 250, the second slide cores 252, and the third slide cores 254.

The plural first, second, and third slide cores 250, 252, and 254 are provided, and each thereof is movably installed in a radial direction. Consequently, the molded gasket may be separated from the cavity in a state in which the second and third slide cores 252 and 254 move outwardly in the radial direction.

Each second slide core 252 operates to be interlocked with the corresponding third slide core 254. To this end, the second slide core 252 is connected to the third slide core 254 through an interlocking pin 253 so that, after the third slide core 254 moves by more than a predetermined distance, the second slide core 252 moves by supply of force through the interlocking pin 253.

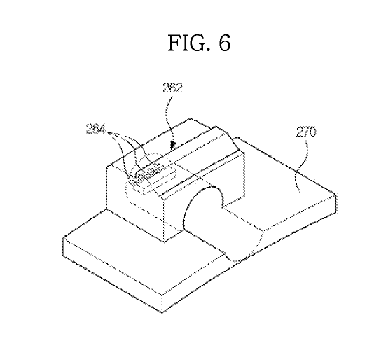

Furthermore, the injection mold 200 includes a runner 260 to allow thermoplastic elastomer injected in a melted state to be dispersively supplied into the cavity, and gates 262 arranged between the runner 260 and the cavity so as to allow the thermoplastic elastomer transferred in the melted state through the runner 260 to be injected into the cavity. In the present exemplary embodiment, the runner 260 is arranged at the first intermediate mold 230, and each gate 262 is arranged at a gate member 270 installed between the runner 260 and the cavity (see FIG. 6).

As the thermoplastic elastomer composition injected into the cavity is mixed with various compounds, fluidity is poor, thereby generating tire marks or flow marks on a surface of the injection molded gasket.

Accordingly, each gate 262 may include a plurality of pin holes 264 so as to allow a melted molding material to be injected into the cavity in a uniformly mixed state.

As such, when the gate 262 is constituted to have the plural pin holes 264, the thermoplastic elastomer is mixed to be evenly dispersed in the course of passing through the pin holes 264, thereby enabling improvement in a surface appearance of the gasket 100.

Each of the pin holes 264 may be about 0.3 mm to 1.0 mm in diameter. Since, when the diameter of the pin hole 264 is greater than 1.0 mm, an injection molding pressure and an injection molding temperature are not sufficiently raised, the surface appearance of the gasket 100 may not be completely improved. Also, since, when the diameter of the pin hole 264 is less than 0.3 mm, flow velocity of the molding material, which passes through the pin holes 264, is too fast to allow the molding material to be properly mixed, the surface appearance of the gasket 100 may not be completely improved.

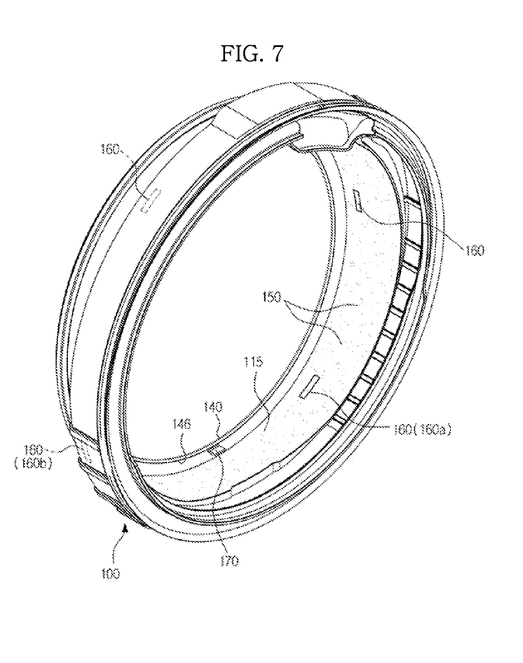

Although the surface appearance of the gasket 100 is improved by application of the pin holes 264 to each gate 262, the flow marks formed on the gasket 100 may not always be removed due to characteristics of the thermoplastic elastomer. Therefore, the surface of the gasket 100 may be formed with fine protrusions 150 (see FIG. 7) so that the flow marks on the surface of the gasket 100 are essentially invisible to the naked eye. The fine protrusions 150 formed on the surface of the gasket 100 irregularly reflect light from the surface of the gasket 100 so as to allow the flow marks surrounding the same to become essentially invisible to the naked eye.

In this case, the fine protrusions may be formed throughout the surface of the gasket 100, but the fine protrusions may also be formed on a portion or portions of the gasket which are most visible to the naked eye.

Since, when the gasket 100 is installed in the laundry treatment apparatus 1, the inner surface 115 of the first circumferential portion 114 is most visible to the naked eye, the inner surface 115 of the first circumferential portion 114 may be formed with the fine protrusions 150 to irregularly reflect light. Surface roughness Ra of the inner surface 115 of the first circumferential portion 114 formed with the fine protrusions 150 may be in a range of about 0.5 μm to 100 μm.

The fine protrusions 150 on the inner surface 115 of the first circumferential portion 114 may be formed by fine patterns (not shown) which are formed on a circumferential surface 232 of the first intermediate mold 230 corresponding to the first circumferential portion 114 of the gasket 100. The fine patterns of the first intermediate mold 230 may be formed through chemical corrosion or mechanical polishing.

Hereinafter, the configuration of the gasket will be described in detail with reference to FIGS. 2, 3, and 7 to 9.

As shown in FIG. 7, the inner surface 115 of the first circumferential portion 114 includes gate corresponding portions 160 formed so as to correspond to the gates 262 arranged at the injection mold 200 for molding of the gasket 100. Each of the gate corresponding portions 160 may be a starting portion in which the gasket 100 is molded by the molding material introduced into the cavity through the corresponding gate 262. The gasket 100 is molded in such a manner that the molding material is introduced into the cavity through the gate 262 of the injection mold 200 and flows out from the gate corresponding portion 160.

By way of example, FIG. 7 shows that the inner surface 115 of the first circumferential portion 114 is formed with four gate corresponding portions 160 as four gates 262 are provided at the injection mold 200. The gate corresponding portions 160 are arranged along the circumferential direction of the first circumferential portion 114. Hereinafter, when any one of the gate corresponding portions 160 is referred to as a first gate corresponding portion 160a, the gate corresponding portion, which is disposed directly next to the first gate corresponding portion 160a in the circumferential direction of the first circumferential portion 114, is referred to as a second gate corresponding portion 160b.

As shown in FIG. 2, the front surface 142 of the lip 140 is a critical portion to prevent water leakage. However, since the front surface 142 of the lip 140 is positioned at a distal end of the gasket 100 and has a thin thickness, poor molding may occur in the course of injection molding of the gasket 100. That is, when gas generated in the course of injection molding the gasket 100 is gathered toward the lip 140 having the thin thickness, the front surface 142 of the lip 140 is not smoothly molded and does not properly perform a sealing function of the door 50. In addition, when the lip 140 is lastly molded in the course of injection molding the gasket 100, the front surface 142 of the lip 140 is formed with a weld line and also does not properly perform the sealing function of the door 50.

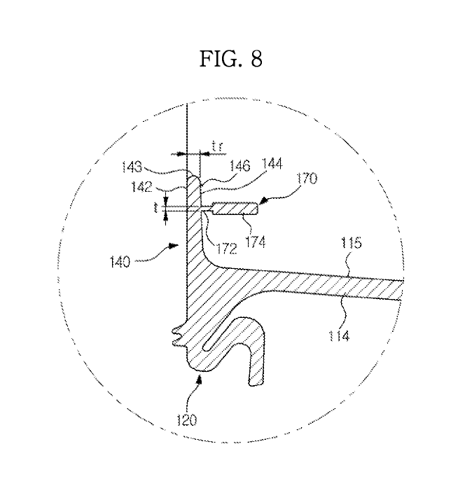

As shown in FIGS. 7 and 8, the gasket 100 includes an overflow protrusion 170 which protrudes from the back surface 144 of the lip 140 so that the overflow protrusion 170 is molded later than the front surface 142 of the lip 140 during injection molding of the gasket 100.

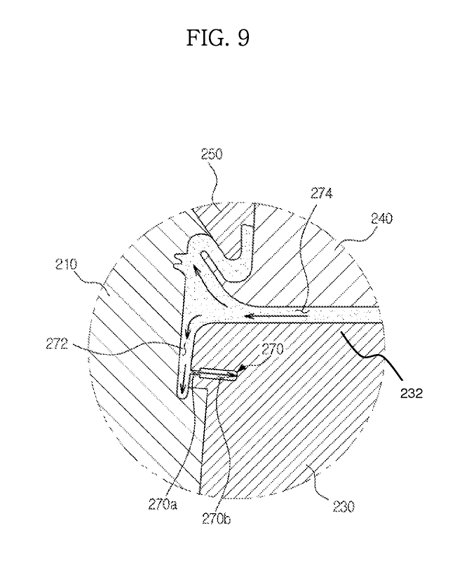

Meanwhile, the injection mold 200 includes an overflow cavity 270 to form the overflow protrusion 170, as shown in FIG. 9. The overflow cavity 270 is arranged at the first intermediate mold 230 to communicate with a lip cavity 272 for formation of the lip 140.

FIG. 9 shows flow of the melted material indicated by an arrow during injection molding of the gasket. During injection molding of the gasket, the molding material is injected toward a cavity 274 for formation of the first circumferential portion 114 to mold the first circumferential portion 114, and then molds the lip 140 and the cabinet coupling part 120.

The lip cavity 272 is filled with the molding material to form the lip 140. In this case, a portion of the molding material is injected into the overflow cavity 270 to form the overflow protrusion 170. The lip 140 is molded earlier than the overflow protrusion 170. That is, the lip cavity 272 is first filled with the molding material before the overflow cavity 270 is fully filled with the molding material. Accordingly, the gas generated during injection molding remains in the overflow cavity 270, thereby enabling prevention of poor molding at the front surface 142 of the lip 140 due to the gas.

As shown in FIG. 8, the overflow protrusion 170 may include a lip connection portion 172 and an enlargement portion 174. The lip connection portion 172 extends rearward from the back surface 144 of the lip 140. The lip connection portion 172 has a thinner thickness t than a minimum thickness tr of the lip 140 so that the overflow protrusion 170 is not molded earlier than the lip 140. The enlargement portion 174 extends rearward from the lip connection portion 172 and is formed thicker than the lip connection portion 172.

In order to correspond to the structure of the overflow protrusion 170, the overflow cavity 270 includes a first portion 270a connected to the lip cavity 272 while being formed narrower than the lip cavity 272, and a second portion 270b connected to the first portion 270a while being formed thicker than the first portion 270a.

The overflow protrusion 170 may be disposed close to an inner side end 143 of the lip 140 which protrudes from the inner surface 115 of the first circumferential portion 114 so as not to be molded earlier than the lip 140 during injection molding. This is believed to be due to the fact that, since the overflow protrusion 170, when being disposed close to the inner surface 115 of the first circumferential portion 114, may be molded earlier than the lip 140 during injection molding, the lip 140 is molded earlier than the overflow protrusion 170 by disposition of the overflow protrusion 170 adjacent to the inner side end 143 of the lip 140.

As shown in FIG. 7, the overflow protrusion 170 may be disposed at a central portion between the first and second gate corresponding portions 160a and 160b with respect to the circumferential direction of the first circumferential portion 114. The central portion between the first and second gate corresponding portions 160a and 160b is an area at which the molding materials injected from two different gates of the injection mold 200 meet, and thus poor molding may occur at the area. Accordingly, when the overflow protrusion 170 is formed at the central portion between the first and second gate corresponding portions 162 and 164, it may effectively prevent poor molding from occurring at the front surface 142 of the lip 140.

Although FIG. 7 shows an example in which one overflow protrusion is formed, a plurality of overflow protrusions may be provided. The plural overflow protrusions may be disposed to be spaced apart from one another along the circumferential direction of the lip 140. In the case of forming two overflow protrusions, the additional overflow protrusion may be formed at an opposite side of the overflow protrusion 170 in the circumferential direction of the lip 140.

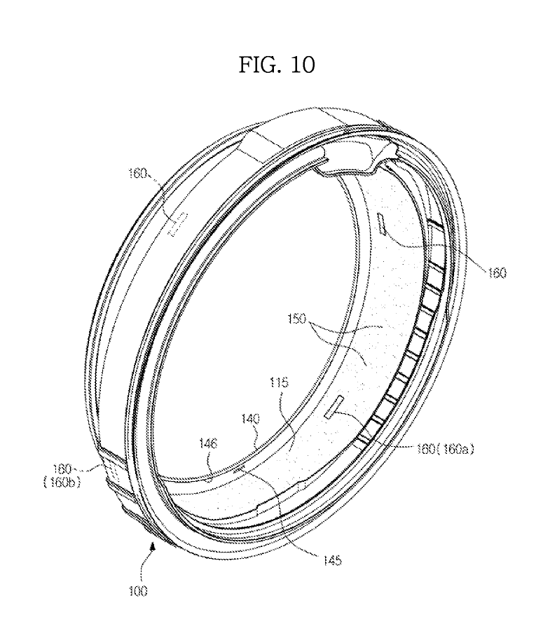

When the gasket 100 shown in FIGS. 3, 7, and 8 is mounted in the laundry treatment apparatus 1, the overflow protrusion 170 may be removed. FIG. 10 shows the gasket from which the overflow protrusion is removed. In the case of removing the overflow protrusion, a cutting surface 145 may remain at the back surface 144 of the lip 140, as shown in FIG. 10.

Referring to FIGS. 7 to 9, the lip 140 is formed with a parting line 146 corresponding to an area at which the two molds 210 and 230 meet during injection molding of the gasket 100, and the parting line 146 is positioned at the back surface 144 of the lip 140.

When the parting line is formed at the front surface 142 of the lip 140, a clearance may be generated between the door 50 and the gasket 100 due to the parting line when the front surface 142 of the lip 140 comes into contact with the door 50, thereby causing generation of water leakage to the outside of the door 50. Therefore, the parting line 146 formed at the lip 140 may be positioned at the back surface of the lip 140. The parting line 146 may be positioned adjacent to the inner side end 143 of the lip 140 at the back surface 144 of the lip 140.

Hereinafter, the following description will be given to provide examples regarding hardness, tensile strength, stability information after being subjected to high-temperature, and a vibration rate of the gasket made from the composition for the gasket by the above-mentioned method.

### Example 1

100 parts by weight of the styrene-ethylene-butylene-styrene (SEBS) as the styrene block copolymer are blended with 15 parts by weight of the polyphenylene ether as the thermally stable polymer at a temperature of about 200° C. to 240° C. Subsequently, such a blended composition is mixed with 90 parts by weight of the paraffin oil, and is then mixed with 12 parts by weight of the polypropylene and 10 parts by weight of the calcium carbonate in order to form a final mixture. Thereafter, the final mixture is molded into a pellet form through extrusion molding, and is then molded into the gasket using an injection machine.

### Example 2

The gasket is molded in the same manner as in Example 1 except that the polyphenylene ether content is 10 parts by weight, the paraffin oil content is 80 parts by weight, the polypropylene content is 15 parts by weight, and the calcium carbonate content is 12 parts by weight.

### Example 3

The gasket is molded in the same manner as in Example 1 except that the polyphenylene ether content is 15 parts by weight, the paraffin oil content is 110 parts by weight, the polypropylene content is 10 parts by weight, and the calcium carbonate content is 20 parts by weight.

### Example 4

The gasket is molded in the same manner as in Example 1 except that the polyphenylene ether content is 15 parts by weight, the paraffin oil content is 150 parts by weight, the polypropylene content is 30 parts by weight, and the calcium carbonate content is 35 parts by weight.

### Test Example

The Shore A hardness and tensile strength of each of the gaskets according to Examples 1 to 4 are tested according to Korean Industrial Standards (KS) M 6518. The results are shown in Table 1. In particular, the high-temperature stretch deformation rate of the gasket represents the ratio of a deformation amount after 24 hours to an initial deformation amount after a load of 500 g/cm2 at 90° C. is applied in a longitudinal direction to a gasket specimen (1.27 cm in width, 6 cm in length, 1.8 mm in thickness). Also, frame vibration is determined as a maximum vibration amount at a right upper corner of a washing machine frame during a spin-drying course of the washing machine mounted with the gasket according to Examples 1 to 4.

TABLE 1

| | Example | Example | Example | Example |
|---|---|---|---|---|
| Section | 1 | 2 | 3 | 4 |
| Hardness (Shore A) | 41 | 42 | 39 | 37 |
| Room temperature | 68 | 71 | 67 | 64 |
| tensile strength | | | | |
| (kgf/cm², 25° C.) | | | | |
| High-temperature | 21 | 20 | 19 | 16 |
| tensile strength | | | | |
| (kgf/cm², 90° C.) | | | | |
| High-temperature stretch | 1.4 | 1.5 | 2.2 | 2.2 |
| deformation rate (%) | | | | |
| Frame vibration (mm) | 1.9 | 1.9 | 1.2 | 1.2 |

As shown in Table 1, it may be understood that the gaskets according to Examples 1 to 4 are high in high-temperature tensile strength and low in high-temperature stretch deformation rate, and vibration of the washing machine is small. Accordingly, even when applied to appliances, operating at high-temperature, such as a washing machine having a boiling function and the like, the gaskets according to Examples 1 to 4 may not be deformed by high-temperature and may attenuate vibration of the washing machine and the like.

Although described with regard to cases applied to the drum washing machine, the gasket according to the exemplary embodiment of the present invention may also be applied to a cloth drying machine and a washing machine with a drying function.

As is apparent from the above description, productivity may be improved by manufacture of a gasket through injection molding, and defective products generated during injection molding or a worn gasket may be easily recycled.

Also, generation of poor molding may be prevented at a contact area with peripheral parts (for example, a door of a laundry treatment apparatus), thereby allowing a gasket to properly perform a sealing function.

In addition, a gasket may have an improved surface appearance.

The disclosure herein has provided example embodiments of a gasket which may be manufactured through injection molding, however the disclosure is not limited to specific embodiments. For example, the gasket has been shown as having four gate corresponding portions and an injection mold having four gates. However, there may be more or less than four gate corresponding portions and more or less than four gates. In addition, a gasket specimen has been disclosed as having specific dimensions. However, the gasket may be larger or smaller than the particular dimensions of the gasket specimen disclosed, and the dimensions of the gasket are not limited to the particular examples provided herein. Further, a door of a laundry treatment apparatus has been described as having a glass portion to view an interior of a drum of the laundry treatment apparatus. However, the door need not include the glass portion.

Although a few embodiments of the present invention have been shown and described, it would be appreciated by those skilled in the art that changes may be made to these embodiments without departing from the principles and spirit of the invention, the scope of which is defined in the claims and their equivalents.

What is claimed is:

1. A gasket applicable to a laundry treatment apparatus including a cabinet having an opening and a door to open and close the opening, the gasket comprising:
a body composed of an injection molded product made from a thermoplastic elastomer, the body having a hollow portion and a circumferential portion enclosing a periphery of the hollow portion;
a lip which protrudes from an edge of the circumferential portion toward the hollow portion, the lip having a front surface which contacts the door when the gasket is installed in the laundry treatment apparatus and a back surface disposed behind the front surface; and
at least one overflow protrusion which protrudes from the back surface of the lip.

2. The gasket according to claim 1, wherein the overflow protrusion comprises a lip connection portion which extends rearward from the back surface of the lip and has a thinner thickness than the lip.

3. The gasket according to claim 2, wherein the overflow protrusion further comprises an enlargement portion which extends rearward from the lip connection portion and is formed thicker than the lip connection portion.

4. The gasket according to claim 1, wherein:
the lip has an inner side end protruding relative to an inner surface of the circumferential portion; and
the overflow protrusion is disposed closer to the inner side end of the lip than the inner surface of the circumferential portion.

5. The gasket according to claim 1, wherein the circumferential portion of the body comprises a plurality of gate corresponding portions formed to respectively correspond to gates arranged at an injection mold for molding of the gasket.

6. The gasket according to claim 5, wherein:
the plural gate corresponding portions are comprised of a first gate corresponding portion and a second gate corresponding portion disposed next to the first gate corresponding portion in a circumferential direction of the body; and
the overflow protrusion is disposed at a central portion between the first and second gate corresponding portions.

7. The gasket according to claim 1, wherein:
the lip is formed with a parting line corresponding to an area at which two molds meet during the molding of the gasket; and
the parting line is positioned at the back surface of the lip.

8. The gasket according to claim 1, wherein the circumferential portion is formed, at an inner surface thereof, with fine protrusions to irregularly reflect light.

9. The gasket according to claim 8, wherein the inner surface of the circumferential portion formed with the fine protrusions has surface roughness in a range of about 0.5 μm to 100 μm.

10. The gasket according to claim 1, wherein the thermoplastic elastomer comprises at least one of styrene-ethylene-butylene-styrene (SEBS), styrene-ethylene-propylene-styrene (SEPS), and styrene-ethylene-ethylene-propylene-styrene (SEEPS).

11. A laundry treatment apparatus comprising:
a cabinet having an opening into which laundry is inserted;
a door mounted at the cabinet to open and close the opening;
a drum rotatably mounted within the cabinet; and
a gasket disposed between the cabinet and the door to attenuate transfer of vibration to the cabinet during rotation of the drum,
wherein the gasket is an injection molded product made from a thermoplastic elastomer and comprises:
a body which has a hollow portion receiving a portion of the door and a circumferential portion enclosing a periphery of the hollow portion; and
a lip which protrudes from the circumferential portion of the body toward the door, having a front surface directed toward the door and a back surface directed toward the drum, and
wherein the lip is formed with a parting line positioned at the back surface thereof.

12. The laundry treatment apparatus according to claim 11, wherein the gasket comprises a cutting surface at the back surface of the lip resulting from removal of a protrusion formed during injection molding of the gasket.

13. The laundry treatment apparatus according to claim 11, wherein the gasket further comprises an overflow protrusion which is formed at the back surface of the lip and is positioned adjacent to the parting line.

14. The laundry treatment apparatus according to claim 11, wherein:
the circumferential portion is formed, at an inner surface thereof, with fine protrusions to irregularly reflect light; and
the inner surface of the circumferential portion formed with the fine protrusions has surface roughness in a range of about 0.5 μm to 100 μm.

15. A manufacturing method for a gasket applicable to a laundry treatment apparatus including a cabinet having an opening and a door to open and close the opening, the manufacturing method comprising:
preparing an injection mold which includes a cavity having a shape corresponding to the gasket to be injection-molded and at least one gate to inject a molding material into the cavity;
injecting a melted thermoplastic elastomer into the cavity through the gate and then forming the gasket having a cylindrical body and a lip protruding from the cylindrical body, the lip having a front surface which is directed toward the door of the laundry treatment apparatus when the gasket is installed in the laundry treatment apparatus;
forming an overflow protrusion at a back surface of the lip, the overflow protrusion being molded later than the front surface of the lip during formation of the lip; and
removing the overflow protrusion from the gasket.

16. The manufacturing method for the gasket according to claim 15, further comprising forming fine protrusions to irregularly reflect light on an inner peripheral surface of the body.

17. The manufacturing method according to claim 15, wherein the at least one gate comprises a plurality of pin holes to allow the melted thermoplastic elastomer to be dispersed and injected into the cavity.

18. The manufacturing method according to claim 17, wherein each of the pin holes is about 0.3 mm to 1.0 mm in diameter.

19. The manufacturing method according to claim 15, wherein:
the injection mold comprises two molds engaged with each other to form a cavity corresponding to the lip; and
the manufacturing method further comprises forming a parting line at the back surface of the lip, the parting line being formed by an area where the two molds are engaged.

20. An injection mold to mold a gasket including a cylindrical body having a circumferential portion and a lip protruding from an end of the circumferential portion, the injection mold comprising:
a first mold and a second mold, disposed to face each other;
a first intermediate mold disposed between the first and second molds, to form a lip cavity corresponding to the lip of the gasket together with the first mold; and
a second intermediate mold disposed at a periphery of the first intermediate mold to form a cavity corresponding to the circumferential portion of the gasket,
wherein the first intermediate mold comprises an overflow cavity communicating with the lip cavity to provide a space capable of being filled with a molding material when the lip cavity is filled with the molding material during injection molding of the gasket.

21. The injection mold according to claim 20, wherein:
the first intermediate mold comprises a circumferential surface to form the cavity corresponding to the circumferential portion of the gasket; and
the circumferential surface is surface-treated to form fine protrusions on the circumferential portion of the gasket.

22. The injection mold according to claim 20, further comprising at least one gate to inject the molding material into at least one cavity formed by the first mold, second mold, the first intermediate mold, and the second intermediate mold.

23. The injection mold according to claim 22, wherein the gate comprises pin holes, and each of the pin holes is about 0.3 mm to 1.0 mm in diameter.

24. The injection mold according to claim 20, wherein the overflow cavity comprises a first portion formed narrower than the lip cavity and a second portion formed wider than the first portion.

25. A gasket usable in a laundry treatment apparatus, the gasket comprising:
a body composed of a thermoplastic elastomer, the body having a hollow portion defining a passage to allow insertion of laundry into an opening of the laundry treatment apparatus when the gasket is installed in the laundry treatment apparatus, and a circumferential portion enclosing a periphery of the hollow portion, wherein the body further comprises:
a first body part having a first front end to couple to an opening portion of the laundry treatment apparatus and a first rear end, and
a second body part having a second front end connected to the first rear end of the first body part and a second rear end to couple to a portion of a tub of the laundry treatment apparatus;
a lip formed at the first front end which protrudes from an inner surface of the circumferential portion toward the hollow portion, the lip having a front surface and a back surface disposed behind the front surface; and
at least one overflow protrusion which protrudes from the back surface of the lip, the at least one overflow protrusion being detachable when the gasket is installed in the laundry treatment apparatus.

26. The gasket of claim 25, wherein the second front end is connected to the first rear end via a connection portion which is bent a plurality of times to attenuate vibration of the tub when the gasket is installed in the laundry treatment apparatus.

27. The gasket of claim 25, wherein the first front end includes a cabinet coupling part to couple to a cabinet of the laundry treatment apparatus when the gasket is installed in the laundry treatment apparatus.

28. The gasket of claim 25, wherein the second body part has a diameter greater than a diameter of the first body part.

29. The gasket of claim 25, further comprising a plurality of gate corresponding portions arranged along a circumferential direction of the inner surface of the circumferential portion, wherein at least one overflow protrusion is centrally disposed between a first gate corresponding portion and a second gate corresponding portion from among the plurality of gate corresponding portions.
